(19) United States
(12) Patent Application Publication
(10) Pub. No.: US 2009/0290028 A1
(43) Pub. Date: Nov. 26, 2009

(54) IMAGING APPARATUS AND IMAGING METHOD

(75) Inventor: Masafumi Yamasaki, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Imaging Corp., Tokyo (JP)

(21) Appl. No.: 12/424,899

(22) Filed: Apr. 16, 2009

(30) Foreign Application Priority Data
May 26, 2008 (JP) 2008-136452

(51) Int. Cl. H04N 5/228; G03B 17/00

(52) U.S. Cl. 348/208.1; 396/55; 348/E05.031

(57) ABSTRACT

An electronic camera 1 comprises an image quality setting unit 37c for setting parameters that determine image quality, a camera-shake limit exposure time computation unit 35 for computing the camera-shake limit exposure time of the imaging device 7 on the basis of the focal length of the imaging lens 3 and the parameters for determining image quality set by the image quality setting unit 37c, an imaging unit 35 for accomplishing photography of the subject consecutively on the basis of the camera-shake limit exposure time, a camera-shake detection unit (39, 19, 43, 45, 47, 49) for detecting the camera-shake amount from the start of exposure of the subject, and an image composition unit (35, 15, 25) for correlating and summing a plurality of frames of image data so that the same portions of the plurality of frames of images displayed respectively by the plurality of frames of image data overlap.

### CROSS-REFERENCE TO RELATED APPLICATION

The present application claims priority from Japanese Application No. 2008-136452, filed on May 26, 2008, the content of which is incorporated herein by reference.

### TECHNICAL FIELD

The present invention relates to an imaging apparatus and imaging method for imaging subjects formed by an imaging lens through photoelectric conversion by an imaging device, and more particularly relates to an imaging apparatus and imaging method for correcting camera-shake of the images caused by shaky hands or the like.

### BACKGROUND OF THE INVENTION

With the imaging apparatuses of electronic cameras and the like that take still photographs, it is required to be able to photograph all kinds of scenes accurately and reliably. However, with still-image photography it is commonly known that camera-shake is induced in images by movement of the subject or camera shake when taking photographs over an extended time. This “camera-shake” of images is one-dimensional (including curved) image haziness and is at times also called “blurriness,” but in the present document this shall be termed “camera-shake,” This “camera-shake” expresses a vector, and includes the direction of the camera-shake and the amount of camera-shake as indicated by the magnitude of the camera-shake. Image camera-shake at times can be actively applied to photography techniques such as panning, but normally this is considered deterioration of image quality and preventing this is indispensable. One representative method of preventing the camera shake is to stably anchor the camera using a tripod or the like, while another method is to use short-time exposures (high-speed shutter), but neither of these can be applied when conditions do not permit and are impossible to apply to hand-held low-lighting photography. In addition, camera-shake-prevention apparatuses are becoming popular that mitigate camera-shake in images formed on the imaging surface of imaging devices by driving the imaging lens or imaging device. However, such camera-shake-prevention apparatuses are complex and require advanced control, thus creating the problem that costs rise and it is difficult to make the camera compact.

As technology to resolve the above-described problems, technology is known such that when, for example, an exposure time longer than a predetermined value is set, time-division photography is accomplished with an exposure time set so as to be less than a predetermined value, for example 1/f (see) (where f is the focal length in mm of the photography lens for 35 mm film), information on relative movement between images is detected on the basis of the plurality of image data obtained, and mutual camera-shake among images is corrected on the basis of this detected movement information, and thus the plurality of image data are combined to obtain a single still image (for example, JP2001086398A).

### SUMMARY OF THE INVENTION

This notwithstanding, it is established that the imaging apparatus disclosed in aforementioned JP2001086398A has points that should be improved, as explained below. That is to say, the amount of image camera-shake that can be tolerated is dependent on the camera-shake frequency, viewing resolution, image observation distance and enlargement magnification when printing the image. For that reason, when these conditions vary, even if photography is accomplished at 1/f (see), the camera-shake may not be sufficiently corrected. In addition, with many electronic cameras that have been proposed in the past, it is possible to set the image quality by selecting an image size, in which the subject image taken by the imaging device is expressed in terms of photoelectrically converted pixel count, and a compression ratio for the image data when recording and storing the photographed image data. However, with the imaging apparatus disclosed in aforementioned JP2001086398, the image quality selection function is not sufficiently realized because multiple images are taken with the 1/f (see) exposure time regardless of image quality mode.

As a method of increasing the accuracy of correcting image camera-shake, shortening the exposure time further in time-division photography may be considered. However, in this case the S/N of the image data declines, so advanced technology is necessary in order to improve the S/N. As one method of improving the S/N, increasing the number of time-division photographs and combining more image data may be considered. However, when this is done, the image processing circuit used to accomplish such things as camera-shake correction and image data composition becomes complicated, the load of image processing becomes heavy and this has a negative effect on other processing, resulting in power consumption increasing.

Accordingly, in consideration of the foregoing, it is an objective of the present invention to provide an imaging apparatus and imaging method that can take subject images while efficiently correcting camera-shake with a precision corresponding to image quality.

The first aspect of the invention which achieves the above-described objective is an imaging apparatus that composes multiple frames of image data so as to reduce mutual camera shaking of the multiple frames of images displayed by each of the multiple frames of image data obtained through time-division photography, comprising: an imaging device for photoelectrically converting the subject images formed by an imaging lens; an image quality setting unit for setting parameters related to the quality of the multiple frames of images; an exposure time computation unit for computing the exposure time in order to make the camera-shake amount of the multiple frames of images less than a permissible value on the basis of the parameters and focal length of the imaging lens; an exposure control unit for controlling exposure of aforementioned imaging device so that multiple frames of images can be photographed consecutively, on the basis of the exposure time; a camera-shake amount detection unit for computing the amount of camera-shake in each of the multiple frames of images; and, an image composition unit for adding the multiple frames of image data in corresponding way so as to achieve overlapping of the same portion of the multiple frames of images displayed by each of the multiple frames of image data, based on the camera-shake amount.

The second aspect of the invention is characterized by the imaging apparatus according to first aspect of the invention wherein the parameters for determining image quality set by the image quality setting unit contain at least one out of the image size or the compression ratio.

The third aspect of the invention which achieves the above-described objective is an imaging method that composes multiple frames of image data so as to reduce mutual camera shaking of the multiple frames of images displayed by each of the multiple frames of image data obtained through time-division photography, including: a step for setting parameters related to the quality of the multiple frames of images; a step for computing the exposure time in order to make the camera-shake amount of the multiple frames of images less than a permissible value, on the basis of the parameters and the focal length of the imaging lens; a step for controlling exposure of the imaging device so that multiple frames of images can be photographed consecutively, on the basis of the exposure time; a step for computing the amount of camera-shake in each of the multiple frames of images; and, a step for adding the multiple frames of image data in corresponding way so as to achieve overlapping of the same portion of the multiple frames of images displayed by each of the multiple frames of image data, based on the camera-shake amount.

With the present invention, it is possible to photograph subjects while efficiently correcting camera-shake with a precision in accordance with the image quality deemed necessary.

### BRIEF DESCRIPTION OF THE DRAWINGS

FIG. 1 is a function block diagram showing the composition of the constituent elements of an electronic camera according to a first embodiment of the present invention.

FIG. 2 shows a schematic external view of the electronic camera illustrated in FIG. 1.

FIG. 3 is a figure showing the movement status of the subject image on the imaging plane when the electronic camera illustrated in FIG. 2 is shaken.

FIG. 4 is a flowchart showing the process of computing in pixel units the movement amounts ΔX and ΔY in the imaging plane when the electronic camera illustrated in FIG. 2 is shaken.

FIG. 5 is a flowchart showing the complete operation of the electronic camera illustrated in FIG. 1.

FIG. 6 is a flowchart showing the operations of the image data memory and image composition processing of the electronic camera illustrated in FIG. 1.

FIG. 7 is a diagram used to explain the image quality mode of the electronic camera illustrated in FIG. 1.

FIG. 8 is a drawing used to explain the camera-shake correction process through the image composition unit illustrated in FIG. 1.

### DESCRIPTION OF THE PREFERRED EMBODIMENTS

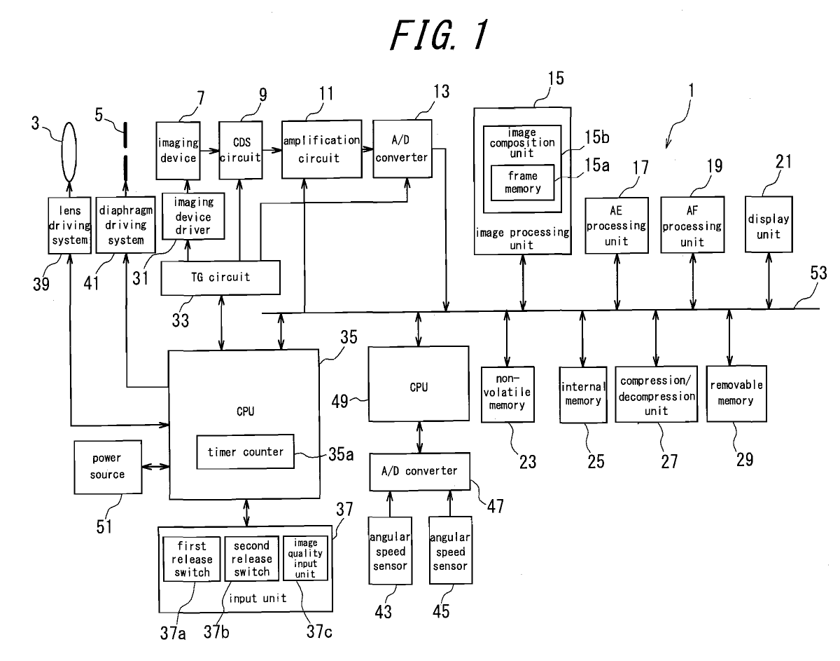

Below, the preferred embodiment of the present invention is explained with reference to the attached FIGS. 1-8.

FIG. 1 is a function block diagram showing the composition of the main components of an electronic camera according to a first embodiment of the present invention. This digital camera 1 has an imaging lens 3, a diaphragm 5, an imaging device 7, a correlated double sampling (CDS) circuit 9, an amplification circuit 11, an analog/digital (A/D) converter 13, an image processing unit 15, and automatic exposure (AE) processing unit 17, an automatic focusing (AF) processing unit 19, a display unit 21, a non-volatile memory 23, an internal memory 25, a compression/decompression unit 27, a removable memory 29, an imaging device driver 31, a timing generator (TG) circuit 33, a first central processing unit (CPU) 35, an input unit 37, a lens driving system 39, a diaphragm driving system 41, angular speed sensors 43 and 45, an analog/digital (A/D) converter 47, a second central processing unit (CPU) 49 and a power source 51.

The imaging lens 3 is controlled by the CPU 35 via the lens driving system 39, and forms an unrepresented subject on the imaging device 7 via the diaphragm 5. The diaphragm 5 is controlled by the CPU 35 via the diaphragm driving system 41.

The imaging device 7 is composed of interline CCD image sensors having, for example, more than 1 million pixels, and uses a device with a Bayer interpolation color filter suited for reading out all pixels through linear successive scanning. This imaging device 7 is driven by the imaging device driver 31 in accordance with transfer pulses from the TG circuit 33 controlled by the CPU 35, and supplies the output signal to the CDS circuit 9.

The CDS circuit 9 removes reset noise and the like from the output signal of the imaging device 7 and supplies the result to the amplification circuit 11 in accordance with the sample hold pulse supplied from the TG circuit 33. The amplification circuit 11 amplifies the output signal from the CDS circuit 9 to the optimal input range for the A/D converter 13 of the later stage, and that amplification ratio is controlled via a bus line 53 by the CPU 35 in accordance with the ISO sensitivity and the image data level in the below-described time-division photography (specifically, the imaging frequency in time-division photography). The A/D converter 13 converts the output signal from the amplification circuit 11 into a digital signal in accordance with the timing pulse supplied from the TG circuit 33 and outputs this to the bus line 53. Time-division photography means taking multiple photographs consecutively within a predetermined exposure time. In addition, the term “image” means a subject image formed by light received on the imaging surface of the imaging device, or a subject image that has become observable through vision by image data being converted.

The image processing unit 15, AE processing unit 17, AS processing unit 19, display unit 21, non-volatile memory 23, internal memory 25, compression/decompression unit 27, removable memory 29, and CPU 49 are connected to the CPU 35 via the bus line 53. The image processing unit 15 processes image data from the A/D converter 13, and has an image composition unit 15b containing frame memory 15a in order to temporarily store image data obtained through time-division photography. The display unit 21 is composed of a liquid crystal monitor and EVF (electronic view finder).

The angular speed sensors 43 and 45 detect the angular speed, which is the amount of change per unit time in the rotational angle about mutually orthogonal axes of revolution, and the output from these is supplied to the CPU 49 after being converted into a digital signal by the A/D converter 47. The CPU 49 uses the output of the angular speed sensors 43 and 45 to compute the amount of camera-shake from the start of exposure of the subject in time-division photography.

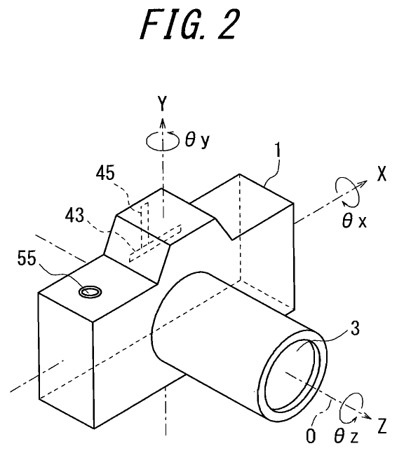

In the present embodiment, as shown in the schematic external view diagram of the electronic camera in FIG. 2, when the direction along the optical axis O of the imaging lens 3 is called the Z axis, the angular speed sensor 43 is positioned so as to detect the angular speed that is the amount of change per unit time of the rotational angle θX about the X axis of rotation, which extends in the left-right direction of the electronic camera 1 in the imaging plane orthogonal to the Z axis. In addition, the angular speed sensor 45 is positioned so as to detect the angular speed that is the amount of change per unit time of the rotational angle θY about the Y axis of rotation, which extends in the up-down direction of the electronic camera 1 orthogonal to the Z axis and X axis through the point of intersection between the Z axis and X axis.

In FIG. 1, the CPU 35 has a time counter that counts the exposure time, and controls the overall operation of the electronic camera 1. The input unit 37 has a first release switch 37a that closes with the first-stage pressing operation of a release button 55 shown in FIG. 2, and a second release switch 37b that closes with the second-stage pressing operation following the first-stage pressing operation. In addition, the input unit 37 sets the image size expressed by the number of pixels with which the subject image formed on the imaging device 7 is photoelectrically converted, and has an image quality input unit 37c constituting the image quality setting unit that sets the compression ratio of the image data when recording and storing photographically obtained image data in the removable memory 29. The input information obtained from this input unit 37 is supplied to the CPU 35.

The electronic camera 1 shown in FIG. 1 is driven by power supplied from the power source 51, and generally speaking is operated as follows. That is to say, when image data of the subject is recorded on the removable memory 29 removably loaded in the electronic camera 1, the image data output from the imaging device 7 is supplied to the image processing unit 15 and the AE processing unit 17 via the CDS 9, the amplification circuit 11 and the A/D converter 13, and in addition to being displayed on the display unit 21 with the white balance and the like automatically adjusted by the image processing unit 15, the standard exposure amount is computed by the AE processing unit 17 and AE control is accomplished by controlling driving of the diaphragm 5 or the imaging device 7 by the CPU 35 on the basis of this exposure amount. Accordingly, the AE processing unit 17 and CPU 35 constitute a standard exposure time computation unit. In this state, the photographer can set the composition and the like of the subject while looking at the display unit 21.

Next, when the first release switch 37a is turned on by the release button 55 shown in FIG. 2 being pressed, the defocus amount is computed by the AF processing unit 19 on the basis of the image data obtained in this state, and AF control is accomplished by the CPU 35 by driving the imaging lens 3 via the lens driving system 39 on the basis of this defocus amount.

Following this, when the second release switch 37b is turned on by the release button 55 being further pressed, the exposure is accomplished for the exposure time Texp on the basis of the standard exposure amount computed by the AE processing unit 19, and image data is composed in the imaging size set by the image quality input unit 37c. Thus, when the exposure time Texp is longer than a predetermined value (the camera-shake limit exposure time Tlimit), image data is composed in a plurality of frames in accordance with time-division photography with an exposure time ΔTexp dependent on the compression ratio and the image size set by the image quality input unit 37 and the focal length of the imaging lens 3, and this plurality of frames of image data is combined by the image composition unit 15b to create the composite image data. In addition, in this case, when a camera-shake amount exceeding the permissible value from the start of exposure of the subject image is detected in the CPU 49, the image processing unit 15 corrects the mutual camera-shake between images on the basis of the camera-shake amount detected by the CPU 49, prior to the plurality of frames of image data obtained through time-division photography being combined. The image data composed by the image composition unit 15b is written to the internal memory 25, undergoes compression processing by the compression/decompression unit 27 in accordance with the compression ratio set by the image quality input unit 37c, and is recorded on the removable memory 29.

In addition, when image data stored on the removable memory 29 is retrieved, the compressed image data read out from the removable memory 29 undergoes decompression processing by the compression/decompression unit 29 and is written to the internal memory 25, and this written-out image data is retrieved in the display unit 21 through image processing by the image processing unit 15. The image data recorded on the removable memory 29 can also be printed by an unrepresented printer or displayed on a big-screen monitor.

Next, the camera-shake amount computed by the CPU 49 will be explained with reference to FIGS. 2 through 4.

In FIG. 2, at a given time the subject side along the optical axis O of the imaging lens 3 shall be called the positive direction on the Z axis, the right side of the electronic camera 1 as viewed from the subject side shall be called the positive direction on the X axis and the upward direction of the electronic camera 1 shall be called the positive direction on the Y axis. In addition, the angle of rotation about the Z axis shall be called θZ. At the above-described given time, the optical axis O of the imaging lens 3 and the Z axis coincide, but at a different time, when camera-shake occurs, the optical axis O of the imaging lens 3 in general does not coincide with the Z axis.

The CPU 49 obtains information relating to the focal length f from the imaging lens 3. For example, when the imaging lens 3 is in power zoom, acquisition of information relating to the focal length f is accomplished via the lens driving system 39, or when the imaging lens is an interchangeable lens barrel, acquisition of information relating to the focal length f is accomplished via the communications contact point. In addition, the CPU 49 acquires subject distance information from the AF processing unit 19. This information on the focal length f and the subject distance information are used in computing the amount of camera-shake in the X direction and the amount of camera-shake in the Y direction, as discussed below.

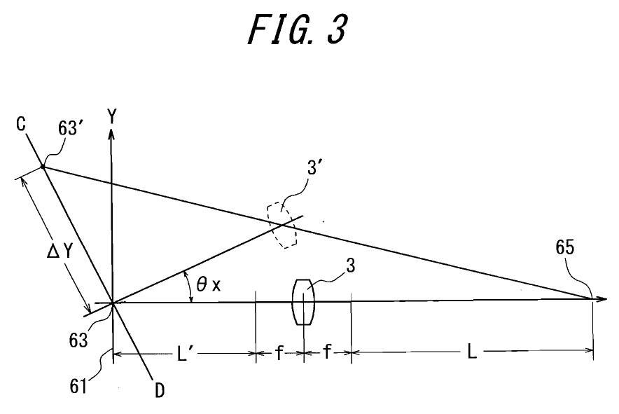

FIG. 3 is a drawing showing the movement situation of the subject image in the imaging plane when the electronic camera 1 experiences camera-shake. Assuming that the electronic camera 1 rotates by the angle of rotation θX as a result of a camera-shake or the like, the imaging lens 3 shifts by rotating from the position indicated by the solid line to the position indicated by the broken line as symbol 3′, and the imaging plane 61 of the imaging device 7 also rotates to the position of the C-D plane inclined by the angle θX. In addition, the image of the subject 65 that is at the central position indicated by symbol 63 when camera-shake does not occur shifts to the position indicated by symbol 63′ on the imaging plane C-D when a camera-shake of the angle of rotation θX occurs.

Calling the focal length of the imaging lens 3 “f”, the distance from the object space focal point of the imaging lens 3 to the subject 65 when a camera-shake does not occur “L,” the distance from the image space focal point of the imaging lens 3 to the subject 65 when a camera-shake does not occur “L′,” and the amount of movement of the image position caused by a camera-shake “ΔY,” the amount of movement ΔY can be computed from equation (2) using Newton's imaging formula shown in equation (1).

L·L′=f² (1)

ΔY=(1+β)²·θX·f (2)

In the above-described equation (2), β indicates the imaging magnification and is f/L. In addition, in equation (2), θX is assumed to be a very small amount and approximation is made to the first order of θX.

The value f in the above-described equation (2) is input as lens information into the CPU 49 as discussed above. In addition, the distance L necessary for computing β is computed based on information from the AF processing unit 19 shown in FIG. 1. Furthermore, the angle θX is computed on the basis of the output from the angular speed sensor 43. Naturally, when L is large compared to f, it is possible to simplify design by omitting β.

Even assuming that a camera-shake occurs in the electronic camera 1, the image formed by the image data output from the imaging device 7 many not be affected by the camera-shake by accomplishing effective correction of the image data after movement on the basis of the movement amount ΔY computed by the above-described equation (2). As discussed above, because the angle θX is very small, even when the imaging plane C-D is inclined by the angle θX about the X axis with respect to the Y axis, the effect on the image created by the inclination of the imaging plane 61 does not present a problem other than the above-described movement amount ΔY.

In addition, even the movement amount ΔX of the imaging position when a camera-shake occurs by the angle of rotation θY about the y axis can be found from equation (3) below the same as equation (2) above.

ΔX=(1+β)²·θY·f (3)

When the two sides of equation (2) above are differentiated with respect to time, equation (4) below is obtained.

d(ΔY)/dt=(1+β)²·f·dθX/dt (4)

In equation (4) above, the d(θX)/dt on the right side is the angular speed about the X axis, so the output of the angular sensor 43 can be used without change. In addition, the d(ΔY)/dt on the left side of equation (4) is the image movement speed Vy in the Y direction when the angular speed d(θX)/dt occurs.

Similarly, the amount of movement ΔX of the image position in the X direction when a camera-shake occurs of the angle of rotation θY about the Y axis can be obtained from equation (5) below by differentiating both sides of equation (3) above with respect to time.

d(ΔX)/dt=(1+β)²·f·dθY/dt (5)

In equation (5) above, the d(θY)/dt on the right side is the angular speed about the Y axis, so the output of the angular sensor 45 can be used without change. In addition, the d(ΔX)/dt on the left side of equation (5) is the image movement speed Vx in the X direction when the angular speed d(θY)/dt occurs.

Assuming that the output d(θX)/dt of the angular speed sensor 43 detected with the period of a predetermined time ΔT is ωx1, ωx2, ωx3, . . . , ωx(n−1), ωxn, the movement amount ΔY in the imaging position in the Y direction after a time n×ΔT has elapsed can be found from equation (6) below. The predetermined time ΔT is the sampling interval in which the A/D converter 47 converts the output from the angular speed sensors 43 and 45 into digital signals, and it is preferable for this to be the same as or shorter than the camera-shake limit exposure time Tlimit.

$$Δ Y = {( 1 + β )}^{2} \cdot f \cdot Δ T \cdot {\sum }_{k = 1}^{n} {ω}_{xk} Λ \qquad ( 6 )$$

Similarly, assuming that the output d(θY)/dt of the angular speed sensor 45 detected each predetermined time ΔT (with a period of the predetermined time ΔT) is ωy1, ωy2, ωy3, . . . , ωy(n−1), ωyn, the movement amount ΔX in the imaging position in the X direction after a time n×ΔT has elapsed can be found from equation (7) below.

$$Δ X = {( 1 + β )}^{2} \cdot f \cdot Δ T \cdot {\sum }_{k = 1}^{n} {ω}_{yk} Λ \qquad ( 7 )$$

From equations (6) and (7) above, it is possible to calculate the camera-shake amount between two frames of images on which exposure control was accomplished by the imaging device 7 with a time interval of n×ΔT. Accordingly, after correcting the camera-shake of the two frames of image data on the basis of the movement amounts (camera-shake amounts) ΔX and ΔY computed from these equations, it is possible to compose image data with camera-shake mitigated by adding the images.

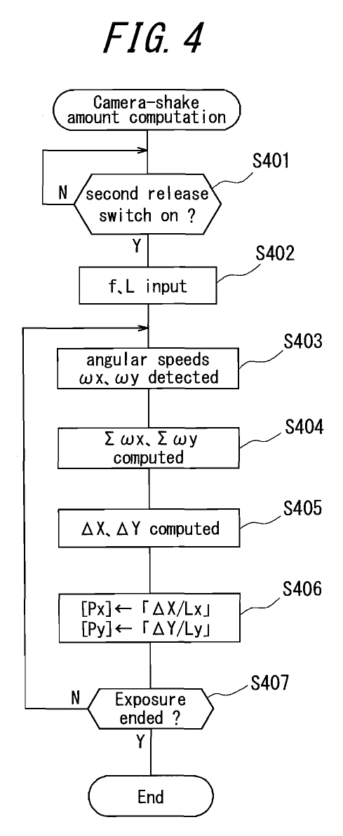

FIG. 4 is a flowchart showing the process of computing the movement amounts ΔX and ΔY in pixel units by the CPU 49. This process is executed as a process independent from other processes during the interval from when the second release switch 37b is closed until the exposure has finished.

For this reason, the CPU 49 observes the switch status of the second release switch 37b via the CPU 35, which receives input information from the input unit 37 (step S401). Furthermore, when it is detected that the second release switch 37b has closed, the focal length f of the imaging lens 3 and the subject distance L are obtained (step S402). These focal length f and subject distance L may be acquired by computations in image processing of the subject, but in order to compute camera-shake amounts with a faster cycle, it is preferable for the focal length f and the subject distance L to be computed using a separate processor or the like and for the CPU 49 to acquire this computed data in step S402. Through this, it is possible to speed up processing and it is possible to achieve high sycophancy in real time.

Next, the CPU 49 inputs the angular speeds ωx and ωy by reading the output of the angular speed sensors 43 and 45 via the A/D converter 47 (step S403). Furthermore, the input angular speeds ωx and ωy are added to the cumulative sum up to the value detected the previous time, and the cumulative sums Σωx and Σωy up to the value detected this time are computed (step S404). Following this, the cumulative sums Σωx and Σωy computed in step S404 are substituted into equations (6) and (7) above, and the movement amounts ΔY and ΔX of the image positions from the final time of the initial photograph in the time-division photography are respectively computed (step S405).

Next, the CPU 49 computes “ΔX/Lx” and “ΔY/Ly”, and these are stored in corresponding memories [Px] and [Py], respectively, built into the CPU 49 (step S406). Lx and Ly represent the sizes of a single pixel of the imaging device 7 in the X direction and Y direction, respectively, and “ΔX/Lx” and “ΔY/Ly” signify the integer value obtained by rounding the fractional part. Accordingly, Px and Py represent in pixel units the movement amounts ΔX and ΔY of the image position from the final point in time of the initial photograph in time-division photography. The symbol [ ] indicates the memory that stores the data inside the brackets.

Following this, the determination is made as to whether or not the exposure of the exposure time Texp has been finished (step S407), and when the exposure is not finished, the same processes as discussed above are repeatedly accomplished from step S403, while when the exposure is finished, this process completes. From the above-described processes, the CPU 49 computes the movement amounts ΔX and ΔY in pixel units. Accordingly, in the present embodiment, the camera-shake amount detection unit is comprised of the lens driving system 39, the AF processing unit 19, the angular speed sensors 43 and 45, the A/D converter 47 and the CPU 49.

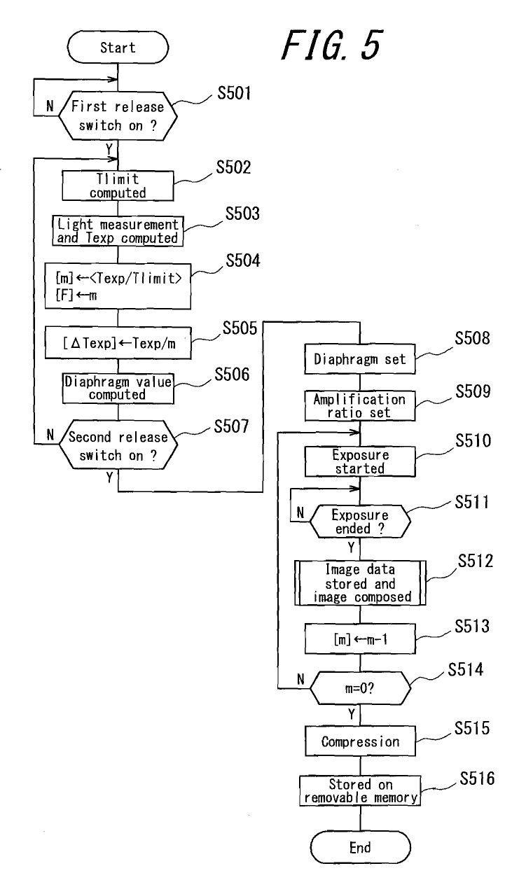

Below, the overall operation of the electronic camera 1 according to this first embodiment will be explained with reference to the flowchart shown in FIG. 5.

When an unrepresented power source switch is turned on, the CPU 35 first determines whether or not the first release switch 37a has come on (step S501). When the result of this determination is that the first release switch 37a is off, the camera remains in a wait status, and when the first release switch 37a comes on, the CPU advances to step S502 and computes the camera-shake limit exposure time Tlimit. Accordingly, in the present embodiment, the CPU 35 constitutes the camera-shake limit exposure time computation unit. This camera-shake limit exposure time Tlimit is the time assumed for the camera-shake amount from the start of exposure to reach the permissible camera-shake amount. Below, this permissible camera-shake amount is explained in detail. In general, when photography is accomplished with an exposure time of 1/f (seq), camera-shakes do not become noticeable. Here, f is the imaging lens focal length when the size of the imaging device 7 is converted to 35 mm film, and the units are mm. Let us theoretically test this principle.

As is clear from equations (6) and (7) above, the angular speeds ωxk and ωyk are fixed values ωxk=ωx and ωyk=ωy regardless of the photographer, and when the subject distance L is sufficiently large compared to the focal length f of the imaging lens 3, in other words when the photographic magnification (β) is sufficiently small, ΔY and ΔX can respectively be represented by equations (8) and (9) below. In equations (8) and (9), ΔTexp is the exposure time in time-division photography (hereafter called “time-division exposure time”).

ΔY≈f·ωx·ΔTexp (8)

ΔX≈f·ωy·ΔTexp (9)

As is clear from equations (8) and (9) above, if ΔTexp is 1/f (see), the movement amounts ΔY and ΔX (of the image plane) caused by camera-shakes in the Y direction and X direction can be seen to be fixed values regardless of the focal length f, regardless of the focal length of the imaging lens 3. This means that when photography is undertaken with an exposure time of 1/f (sec), camera-shakes (ΔX, ΔY) can be kept within a permissible circle of confusion under predetermined observation conditions.

However, the camera-shake amounts that can be permitted depend on the enlarging magnification when printing the image, the observation distance of the image, the resolution of viewing, the camera-shake frequency and so forth, as discussed above, so if these conditions differ, the camera-shake prevention effect can be insufficient even if photography is undertaken with an exposure time of 1/f (sec). In addition, since many electronic cameras allow the image size and compression ratio to be selected, if performing time-division photography with an exposure time of 1/f (see) regardless of these settings, the selection functions for image size and compression ratio cannot be adequately taken advantage of.

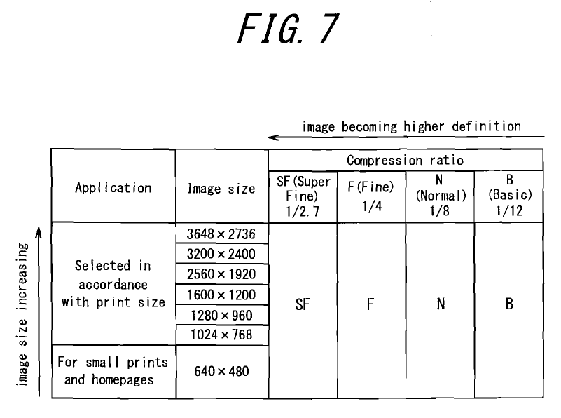

In the present embodiment, the image quality mode of the image photographed can be set in the image quality input unit 37c by combining image size and compression ratio in accordance with applications such as print size, as shown in FIG. 7. That is to say, as the image size, one image size can be selected in accordance with application from among the seven sizes of 640×480, 1024, 768, 1280×960, 1600×1200, 2560×1920, 3200×2400 and 3648×2736. Here, the image size is expressed by pixel count. In addition, as the compression ratio, an arbitrary compression ratio can be selected in each image size from among the four ratios of 1/12 or B (Basic), 1/8 or N (Normal), 1/4 or F (Fine) or 1/2.7 or SF (Super Fine).

In the image quality mode shown in FIG. 7, with the present embodiment when an image photographed with an image size of 1280×960 and a compression ratio of N is enlarged to cabinet size (120 mm×165 mm) and viewed from a distance of 40 cm, the exposure time such that camera-shakes are not noticeable is 1/fo (seq) (where fo is the focal length (mm) of the imaging lens 3).

In addition, when photography is undertaken with a large image size, it is generally thought that the intent is to enlarge the print size and appreciate the beautiful image. Hence, as an example, an image photographed with another image size is assumed to be enlarged to a size proportional to the image size and is printed and observed from the same distance of 40 cm. In this case, because the camera-shakes on the print are enlarged or reduced in proportion to the enlargement magnification of the print, in order to control camera-shakes on the print to below a given permissible camera-shake amount regardless of image size, it is necessary for the permissible camera-shake amount during photography to be reduced inversely proportional to the image size.

In the present embodiment, the camera-shake limit exposure time Tlimit is shortened virtually inverse-proportionally to the image size. That is to say, for an image size set by the image quality input unit 37c of 1280×960 as the standard for 1/fo (sec), when the magnification is K1 (here, K1 is a ratio of the long side or the short side indicating image size) the camera-shake limit exposure time Tlimit is 1/(K1·fo) (sec). For example, for image sizes (640×480, 1024, 768, 1280×960, 1600×1200, 2560×1920, 3200×2400 and 3648×2736), the value of K1 is (0.5, 0.8, 11, 1.25, 2, 2.5, 2.85).

In addition, because the image quality deteriorates with the compression ratio, the higher the compression ratio the larger the camera-shake tolerance. For example, defining K2 the coefficient corresponding to the compression ratio, the camera-shake limit exposure time Tlimit becomes 1/(K1·K2·fo) (sec). Here, the value of K2 is 1 when the compression ratio is N, and is smaller than 1 when the ratio is B, and is larger than 1 when the ratio is F, and is even larger when the ratio is SF than when the ratio is F. In the present embodiment, in correspondence with the compression ratios (SF, F, N, B), the values of K2 are (1.7, 1.4, 1, 0.8).

The values K1 and K2 above are stored in the non-volatile memory 23 either as independent values or as the value (K1·K2). In the present embodiment, the camera-shake limit exposure time Tlimit is computed using both the image size and the compression ratio as parameters determining image quality, but the camera-shake limit exposure time Tlimit may also be computed using only one out of the image size and the compression ratio as a parameter.

In FIG. 5, the CPU 35 computes the camera-shake limit exposure time Tlimit=1/(K1·K2·fo) in step S502. Here, K1 and K2 are the values stored in advance in the non-volatile memory 23 as discussed above, and fo is the focal length of the imaging lens 3. This focal length fo of the imaging lens 3 may be calculated back from the driving amount when the imaging lens 3 is driven by the lens driving system 39, or may be detected by an encoder that detects the position of the imaging lens 3.

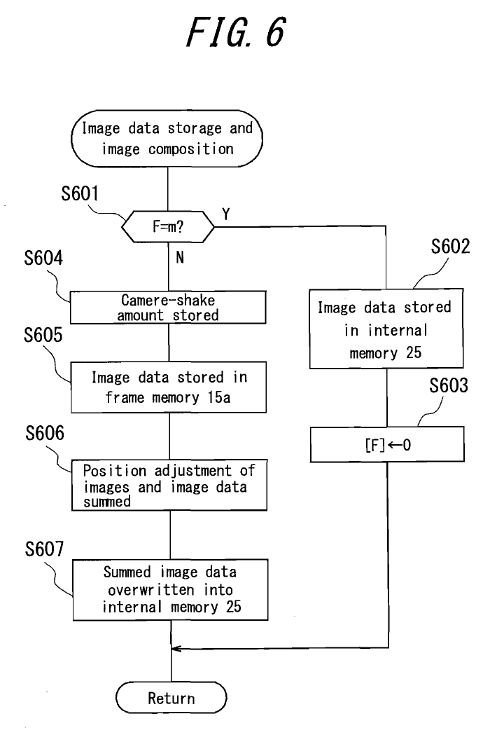

Next, light measurement is accomplished by the AE processing unit 19, and the shutter speed Texp (hereafter called the standard exposure time) necessary to obtain the amount of light received by the imaging plane of the imagine device 7 in order to obtain the standard signal level is computed using apex computations (step S503). Next, the CPIJ 35 computes <Texp/Tlimit> (step S504). Here, <Texp/Tlimit> is an integer value m obtained by rounding up the fractional part, and Texp is the exposure time in normal photography. The computation result m of <Texp/Tlimit> is stored in the internal memory 25. The apex computations are commonly known computations for calculating exposure values, and when the apex values of the shutter speed, diaphragm, subject luminosity and ISO sensitivity are respectively called Tv, Av, Bv and Sv, the various exposure parameters can be computed from the relationship in equation (10) below. In addition, m is stored in memory [F] (step S504). This signifies storing m in a memory separate from memory [m] as a new variable F. This variable F is used in below-described FIG. 6.

Tv+Av=Bv+Sv (10)

In the present embodiment, <Texp/Tlimit> is an integer value obtained by rounding up the fractional part, but as long as <Texp/Tlimit> is an integer value, the fractional part may be truncated instead, and in addition, may be a close integer value selected from among predetermined integers. In any case, this may be an integer value close to the computed result for <Texp/Tlimit>. In addition, for the standard exposure time Texp, a value for standard exposure was obtained on the basis of light measurement, but this is intended to be illustrative and not limiting, for this may also be the shutter speed set manually by the photographer.

Next, the CPU 35 divides the standard exposure time Texp by the integer value m to obtain the time-division exposure time ΔTexp and stores that result in a predetermined memory (step S505). The time-division exposure time ΔTexp obtained in this manner is an exposure time close to the camera-shake limit exposure time Tlimit, and is effectively an exposure time in which the camera-shake is permissible. Next, the diaphragm value is computed on the basis of apex computations (step S506). Here, the subject luminosity value Bv on the right side of equation (10) above is a value found through light measurement in step S503, and in addition, the ISO sensitivity value Sv is a default value or a value input by the photographer through the input unit 37. Accordingly, Tv and Av on the left side of equation (10) above are suitably computed following a predetermined program line. When the ISO sensitivity is S times higher, the exposure amount becomes 1/S, so the amplification ratio of the amplification circuit 11 is controlled in accordance with the ISO sensitivity.

Next, the CPU 35 determines whether or not the second release switch 37b is on (step S507). As a result, when the second release switch 37b is off, the processes from above-described steps S502 through S506 are repeated and the CPU waits for the second release switch 37b to turn on. When the first release switch 37a also turns off during this time, the CPU returns to step S501.

When the second release switch 37b turns on in step S507, the photography operation starts. In this photography operation, first the diaphragm setting is made (step S508). Here, the diaphragm 5, which is in an open state, is narrowed by the diaphragm driving system 41 to the diaphragm value obtained in step S506. Next, the amplification ratio of the amplification circuit is set to m (step S509). That is to say, in time-division photography in which the m computed in step S504 is m>2, the exposure amounts of the various images become 1/m to the exposure amount obtained through the standard exposure time Texp when m=1. In this way, the image data from the CDS circuit 9 is amplified m times by the amplification circuit 11 and is output to the A/D converter 13. Here, the amplification ratio of the amplification circuit changes depending on the ISO sensitivity as discussed above, but in the present embodiment, 1 will be used as the amplification ratio through ISO sensitivity.

Next, the CPU 35 starts exposure of the imaging device 7 (step S510), and determines through the timer counter 35a whether or not the time-division exposure time ΔTexp has elapsed from the start of exposure (step S511). As a result, when the exposure is finished, the image data read out from the imaging device 7 and the camera-shake amount corresponding to this image data are linked and stored in the frame memory 15a or the internal memory 25 and are composed after the camera-shake between images is corrected on the basis of this camera-shake amount. The storing of this camera-shake amount and the image data and the process of image composition (step S512) are explained in detail below with reference to FIG. 6.

Next, the CPU 35 subtracts 1 from the photography count m in time-division photography (step S513). Next, the CPU 35 determines whether or not in is 0 (step S514). As a result, when m=0, after the image data stored in the internal memory 25 is compressed by the compression/decompression unit 27, it is recorded in the removable memory 29 as still image data through said time-division photography and the photography action is completed. Accordingly, when the m computed in step S504 is 1, that is to say when the camera-shake limit exposure time Tlimit corresponding to the image quality mode computed in step S502 and the exposure time Texp computed in step S503 are virtually identical, photography completes with a single exposure. In contrast, when the m computed in step S504 is two or more, steps S510 through S514 are repeated and the subsequent time-division photography is accomplished through the time-division photography time ΔTexp.

Next, the flow of storing image data and the image composition process in step S512 will be explained in detail with reference to FIG. 6. First, the determination is made as to whether or not F is m (step S601). This F is the value stored in memory [F] in step S504 of FIG. 5, and is equivalent to the photography count m in time-division photography. When F=m in step S601 the image data read out from the imaging device 7 is stored in the internal memory 25 (step S602). Here, F=m is always the case immediately after the initial imaging in time-division photography. Next, 0 is stored in the memory [F] (step S603). When it is determined in step S601 that F does not equal m, that is to say when m is 2 or more, next the camera-shake amounts Px and Py in pixel units in the X direction and Y direction stored in the memory built into the CPU 49 (see step S406 in FIG. 4) are linked to the image data read out from the imaging device 7 and stored in the internal memory 25 (step S604). These camera-shake amounts, as has already been stated, express in pixel units the movement amounts ΔX and ΔY of the image position from the end point in time of the initial photograph in time-division photography.

Next, the image data read out from the imaging device 7 is stored in the frame memory 15a (step S605). Next, position adjustment is accomplished on the basis of the camera-shake amounts stored in the internal memory 25 so that the image (called image B) displayed by the image data (called image data B) stored in the frame memory 15a matches the image (called image A) displayed by the image data (called image data A) already stored in the internal memory 25, and the image data corresponding to the image data A and image data B are summed by the CPU 35 (step S606). Next, this summed image data is overwritten into the original address in the internal memory 25 where the image data A was stored (step S607). The above process is repeated until the time-division photography is completed. When this occurs, stored in the internal memory 25 is a summed composite image corresponding to the plurality of frames of image data such that the images displayed by the respective image data of the plurality of frames matches on the basis of data relating to camera-shakes. Accordingly, the CPU 35, the image processing unit 15 and the internal memory 25 constitute the image composition unit.

Next, a detailed explanation will be given for the image positioning and image summing processes in step S606. Let us call the camera-shake amounts in the X and Y directions of the image displayed by the image data B Px(B) and Py(B), respectively. As already stated, Px(B) and Py(B) express in pixel units the movement amounts ΔX and ΔY of the image positions from the end point in time of the initial photograph in time-division photography. Accordingly, Px(B) and Py(B) are camera-shake amounts based on the image A displayed by image data A recorded in the internal memory 25, and the camera-shake amounts in the X direction and Y direction of image B relative to image A are respectively Px(B) and Py(B).

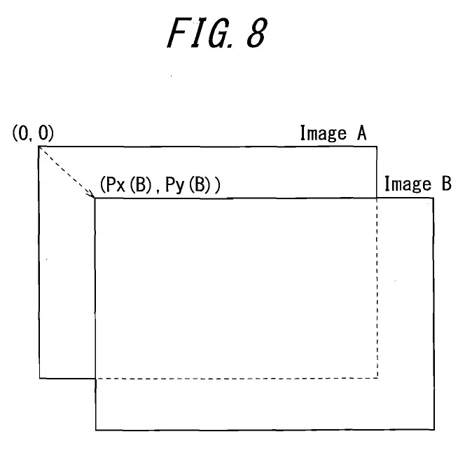

FIG. 8 is an illustration of the mutual positional relationship when the same portions of image A and image B overlap. The CPU 35 reads out the image data B corresponding to the image B from the frame memory 15a and also reads out the image data A corresponding to the image A from the frame memory 15a, sums the image data of the positions where the same portions of image A and image B overlapped in FIG. 8, again stores this in the internal memory 25 and calls this the new image data B. This position adjustment between images and summing of image data is executed until time-division photography is completed.

The read-out of image data from the imaging device 7 is accomplished at high speed compared to image composition processing, so the frame memory 15a functions as a buffer memory to compensate for this time difference. In the present embodiment, the frame memory 15a and internal memory 25 are separated for convenience in explanations, but the frame memory 15a may be a portion of the internal memory 25.

As discussed above, the total exposure time (m ΔTexp) for m times of photography obtained by controlling exposure with the exposure time ΔTexp is equivalent to the standard exposure time Texp. Accordingly, the shot noise level of the imaging device contained in the image composed of images in which mutual camera-shakes of images obtained through m times of photography in time-division photography are corrected is statistically equivalent to the shot noise level contained in images obtained by photography with the standard exposure time Texp, so it is possible to maintain high image quality despite time-division photography.

The imaging apparatus and imaging method discussed above include the embodiments illustrated below. Below, embodiments included in the present invention are illustrated. The contents detailed in these various embodiments can be arbitrarily combined to the extent that there are no contradictions.

### Modified Embodiment 1

In the embodiment explained above, camera-shake correction and image composition are accomplished based on the image data read out from the imaging device 7. However, the imaging device 7 many be composed so as to have at least one of the camera-shake correction or image composition functions.

### Modified Embodiment 2

In the embodiment explained above, the camera-shake amounts of the image obtained using the angular speed sensors 43 and 45 or the like are linked to the various image data obtained in time-division photography and stored in the internal memory 25, and camera-shake between images is corrected based on the camera-shake amounts recorded in this internal memory 25. However, the camera-shake between images in time-division photography may be obtained using image processing such as commonly known movement vector detection, without using the angular speed sensors 43 and 45.

### Modified Embodiment 3

In the embodiment explained above, high-speed image composition processing is enabled by processing in real time camera-shake correction and image composition with image data that has already been read out and has undergone camera-shake correction to compose an image, each time the image signal is read out from the imaging device 7. However, image composition may also be accomplished after all image data in time-division photography has been stored in the internal memory 25 and after correction processing is accomplished so that the mutual camera-shakes between images displayed by a plurality of frames of image data are corrected.

### Modified Embodiment 4

In the embodiment explained above, the photography count (nm) was controlled so that the total exposure time (m·ΔTexp) of the plurality of photographs in time-division photography is equal to the standard exposure time Texp. However, it would also be fine to correct and compose mutual camera-shakes of a plurality of frames of images obtained through photography a number of times other than aforementioned m times using the camera-shake limit exposure time Tlimit. The reason is that while composing the image data obtained through m times of photography mitigates random noise in the image data, the photography count m obtained through computation is not necessarily an absolute in the present embodiment. In addition, the present invention aims to mitigate camera-shakes, so a composition for mitigating random noise contained in the image data is not necessarily directly related to the present invention.

### Modified Embodiment 5

In this embodiment, the exposure time ΔTexp in time-division photography was set to the limit value that makes the camera-shake amount permissible (camera-shake limit exposure time Tlimit). However, this standard exposure time ΔTexp may also be a time shorter than aforementioned camera-shake limit exposure time Tlimit.

### Modified Embodiment 6

In the embodiment explained above, the image quality parameters are input by the operator through the image quality input unit 37c. However, these may be automatically set, for example, in accordance with the remaining memory capacity of the removable memory 29.

In the embodiment explained above, when the image size is 1280×960 pixels and an image photographed with a compression ratio of N is enlarged to cabinet size (120 mm×165 mm) and observed from a distance of 40 cm, the exposure time so that camera-shakes are not noticeable is set to 1/fo (see) (here, fo is the focal length (mm) of the imaging lens 3) and the camera-shake limit exposure time Tlimit of the imaging device 7 is computed on the basis of the compression ratio and image size set by the image quality input unit 37c based on this exposure time 1/fo (sec). Furthermore, in addition to accomplishing photography of a subject a plurality m times consecutively in accordance with the standard exposure time Texp on the basis of the standard exposure time Texp of the imaging device 7 computed by the AE control and the computed camera-shake limit exposure time Tlimit, the camera-shake amount from the start of exposure of the subject is detected, and when the camera-shake amount is greater than the permissible value, composition image data is obtained in which the camera-shake is mitigated by summing aforementioned plurality of frames of image data so that the same portion of the plurality of frames of images displayed by the respective plurality m frames of image data obtained through the plurality m times of photography overlap. Accordingly, it is possible to photograph a subject while efficiently correcting camera-shakes with accuracy in accordance with the needed image quality.

### REFERENCE NUMERALS

1 electronic camera
3 imaging lens
5 diaphragm
7 imaging device
9 correlated double sampling (CDS) circuit
11 amplification circuit
13 analog/digital (A/D) converter
15 image processing unit
5a frame memory
15b image composition unit
17 automatic exposure (AE) processing unit
19 automatic focusing (AF) processing unit
21 display unit
23 non-volatile memory
25 internal memory
27 compression/decompression unit
29 removable memory
31 imaging device driver
33 timing generator (TG) circuit
35 first central processing unit (CPU)
35a timer counter
37 input unit
37a first release switch
37b second release switch
37c image quality input unit
39 lens driving system
41 diaphragm driving system
43, 45 angular speed sensors
47 analog/digital (A/D) converter
49 second central processing unit (CPU)
51 power source
53 bus line
61 imaging plane
65 subject

What is claimed is:

1. An imaging apparatus that composes multiple frames of image data so as to reduce mutual camera shaking of the multiple frames of images displayed by each of the multiple frames of image data obtained through time-division photography, comprising:
an imaging device for photoelectrically converting the subject images formed by an imaging lens;
an image quality setting unit for setting parameters related to the quality of the multiple frames of images;
an exposure time computation unit for computing the exposure time in order to make the camera-shake amount of the multiple frames of images less than a permissible value on the basis of the parameters and focal length of the imaging lens;
an exposure control unit for controlling exposure of aforementioned imaging device so that multiple frames of images can be photographed consecutively, on the basis of the exposure time;
a camera-shake amount detection unit for computing the amount of camera-shake in each of the multiple frames of images; and,
an image composition unit for adding the multiple frames of image data in corresponding way so as to achieve overlapping of the same portion of the multiple frames of images displayed by each of the multiple frames of image data based on the camera-shake amount.

2. The imaging apparatus of claim 1, wherein the parameters for determining image quality set by the image quality setting unit contain at least one out of the image size or the compression ratio.

3. An imaging method that composes multiple frames of image data so as to reduce mutual camera shaking of the multiple frames of images displayed by each of the multiple frames of image data obtained through time-division photography, including:
a step for setting parameters related to the quality of the multiple frames of images;
a step for computing the exposure time in order to make the camera-shake amount of the multiple frames of images less than a permissible value, on the basis of the parameters and the focal length of the imaging lens;
a step for controlling exposure of the imaging device so that multiple frames of images can be photographed consecutively, on the basis of the exposure time;
a step for computing the amount of camera-shake in each of the multiple frames of images; and,
a step for adding the multiple frames of image data in corresponding way so as to achieve overlapping of the same portion of the multiple frames of images displayed by each of the multiple frames of image data, based on the camera-shake amount.
